(19) United States
(12) Patent Application Publication
(10) Pub. No.: US 2025/0155552 A1
(43) Pub. Date: May 15, 2025

(54) MIMO Radar Apparatus

(71) Applicant: Shenzhen Yinwang Intelligent Technologies Co., Ltd., Shenzhen (CN)

(72) Inventors: Sergio Duque Biarge, Munich (DE); Simon Tejero Alfageme, Munich (DE); Alberto Perez Monjas, Munich (DE); Jordi Balcells Ventura, Munich (DE); Alessandro Tinti, Munich (DE)

(73) Assignee: Shenzhen Yinwang Intelligent Technologies Co., Ltd., Shenzhen (CN)

(21) Appl. No.: 19/026,258

(22) Filed: Jan. 16, 2025

Related U.S. Application Data
(63) Continuation of application No. PCT/EP2022/070896, filed on Jul. 26, 2022.

(51) Int. Cl. G01S 7/35

(52) U.S. Cl. CPC G01S 7/358; G01S 7/354

(57) ABSTRACT

A MIMO radar apparatus with a high angular resolution includes: a transmission device configured to transmit a MIMO radar waveform comprising circulating N waveforms forming the MIMO radar waveform through N transmission channels, N being an integer larger than 1, with a constant relative time shift between the circulating N waveforms; and a reception device configured to receive over N reception channels reception signals resulting from reflections of the transmitted MIMO radar waveform. The transmission device is configured to generate the MIMO radar waveform, generate a reference signal, and provide the reception device with the generated reference signal. The reception device is configured to perform IQ mixing of the reception signals based on the reference signal to obtain intermediate frequency signals and perform analog-digital conversion on the obtained intermediate frequency signals to obtain analog-digital converted reception signals.

### CROSS-REFERENCE TO RELATED APPLICATIONS

This application is a continuation n of International Application No. PCT/EP2022/070896, filed on Jul. 26, 2022, the disclosure of which is hereby incorporated by reference in its entirety.

### TECHNICAL FIELD

The present disclosure relates to a Multiple-Input-Multiple-Output (MIMO) radar apparatus, in particular, a digital MIMO radar apparatus suitable for automotive applications.

### BACKGROUND

Radar apparatuses are ubiquitously used for the detection of objects. For example, in automotive applications radar apparatuses are used for determining distances to a variety of objects and are part of driver assistance systems. Radar apparatuses prove helpful for obstacle avoidance and autonomous driving.

Multiple-Input-Multiple-Output (MIMO) radar apparatuses with multiple transmission and reception antennas offer a variety of advantages with respect to the accuracy of object detection. Particularly, MIMO radar apparatuses provide large virtual apertures and, thereby, high angular resolutions in a relatively cost efficient manner.

Analog MIMO radar apparatuses are commonly used in different applications, involve relative simple processing and are known to be relatively robust to signal saturation caused by strongly reflecting nearby objects. However, the number of transmitters that can be used is limited. Digital MIMO radar apparatuses of the art may be superior to analog ones with respect to accuracy of object detection but are more complex and more expensive, for example, since analog-digital converters need to be able to process fast and with a high dynamic range in order to avoid saturation caused by strongly reflecting nearby objects.

For example, DE 10 2016 224 945 A1 teaches a digital Frequency Modulation Continuous Wave (FMCW) radar apparatus wherein radar signals are digitally generated, subsequently IQ (In-Phase-&-Quadrature) modulated, up-converted, amplified and transmitted into the air by the transmission antennas. On the receiver side, signals are received by reception antennas, IQ mixed using a reference signal, passed through a notch filter bank to avoid saturation due to strong reflections by nearby objects, analog-digital converted and finally processed by a computing unit. However, the transmission bandwidth increases with the number of transmission antennas used. In addition, the time-frequency domain of the MIMO waveform is not efficiently used. This implies a large occupied transmission bandwidth which in course demands for an expensive digital-analog converter with a high sampling rate. In addition, the need for a relatively large transmission bandwidth poses problems with respect to statutory spectrum regulations.

### SUMMARY

Exemplary embodiments of the present application provide a MIMO radar apparatus that allows for object detection with a high angular resolution at low costs.

According to a first aspect, it is provided a MIMO radar apparatus comprising a transmission device configured to transmit a MIMO radar waveform comprising circulating N waveforms forming the MIMO radar waveform through N transmission channels, N being an integer larger than 1, with a constant relative time shift (constant frequency spacing) between the individual circulating N waveforms and a reception device configured to receive over N reception channels reception signals resulting from reflections of the transmitted MIMO radar waveform. The transmission device comprises generation means configured to generate the MIMO radar waveform, generate a reference signal (for example, one of the N waveforms), and provide the reception device with the generated reference signal. The reception device is configured to perform IQ mixing (demodulation) of the reception signals based on the reference signal to obtain intermediate frequency signals and analog-digital convert the obtained intermediate frequency signals (by means of analog-digital converters) to obtain analog-digital converted reception signals.

Each of the transmission antennas radiates simultaneously. The same waveform circulates through the same transmission channel. For example: At the beginning of a radar pulse the n-th transmission channel (n=0, . . . , N−1) provides a waveform with a frequency of n Δf. The frequency of the waveform (linearly) increases in time until a predetermined bandwidth is reached. After the bandwidth has been reached the waveform is further transmitted (if the end of the pulse period is not already reached) in the same transmission channel starting with the frequency Δf and the frequency (linearly) increasing in time until the end of the pulse period. There is a constant time shift for reaching the same frequency between neighbored transmission channels.

Thus, the MIMO radar apparatus provided herein operates based on both (Linear) FMCW modulation and circulating individual signals (a circulating code). This configuration allows for using multiples transmitters simultaneously and, thus, obtaining a high-density map due to a large aperture with high angular resolution and sensitivity for detecting weakly reflecting objects. A very compact and efficient spectrum can be used due to the employment of the circulating waveforms and the transmission bandwidth does not necessarily increase with the number of transmission antennas used. This facilitates the frequency hopping for interference avoidance in the allowed spectrum and complying with statutory spectrum regulations.

According to an implementation, the reception device of the MIMO radar apparatus according to the first aspect is configured to analog-digital convert the obtained intermediate frequency signals with a sampling frequency fₛ given by fₛ=N Δf, wherein Δf denotes a constant frequency spacing between the N transmission channels. The particular sampling allows for obtaining range profiles based on frequencies of the received signal and a relatively simple spectrum analysis (for example an FFT) without complex processing. Details of this particular sampling are given in the description below.

According to another implementation, all of the circulating N waveforms (having frequencies depending linearly on time) apart from the respective initial frequencies have the same chirp parameters. Particularly, the frequency-time slopes of all of the N waveforms may be the same. The amplitudes of all of the waveforms may also be the same.

According to another implementation, one of the transmission device and the reception device comprises phase shifting means configured to phase shift the reference signal by 90° to obtain a phase shifted reference signal and the reception device is configured to perform the IQ mixing (demodulation) based on the phase shifted reference signal. Thus, it can be suitably selected from either the phase shifted reference signal being provided by the transmission device or being generated by the reception device thereby increasing flexibility of the design of the overall configuration.

According to another implementation, the generation means comprise a digital signal generator configured to generate digital transmission signals and a digital-analog converter configured to digital-analog convert the digital transmission signals to obtain analog transmission signals. In other words, a fully digital MIMO radar apparatus is provided in this implementation. Particularly, the generation means may comprise a local oscillator configured to up-convert in frequency the generated digital transmission signals to the desired carrier frequency.

According to another implementation, the generation means comprise low-pass filters configured to low-pass filter the analog transmission signals. The low-pass filtering allows for reducing non-linearities that might be present in the digital-analog converted signals.

According to another implementation, the reception device comprises analog filter banks configured to filter the intermediate frequency signals for adjusting amplitudes of the intermediate frequency signals to avoid analog-to digital conversion saturation. Thus, a high dynamic range of objects to be detected can be dealt with without the need for expensive analog-digital converters having very high dynamic ranges. The MIMO radar apparatus is robust against strong reflection signals coming from nearby objects. The use of notch filters might prove particularly useful in this respect.

The MIMO radar apparatus of the first aspect and any of the above-described implementations may be used for determining a variety of spatial parameters of a detected object. According to an implementation, the reception device comprises a digital processing unit configured to receive the analog-digital converted reception signals and determine at least one of a location of or distance to the MIMO radar apparatus, angle to the MIMO radar apparatus, direction relative to the MIMO radar apparatus, and velocity relative to the MIMO radar apparatus of an object generating the reflections of the transmitted MIMO radar waveform based on these signals.

According to second aspect, it is provided a device comprising the MIMO radar apparatus according to the first aspect or any of the above-described implementation, wherein the device is one of a vehicle, an automobile, an automated guided vehicle, a robot, a home monitoring system, and a health monitoring system. All of these devices may benefit from the high angular resolution of the MIMO radar apparatus realized based on a relatively inexpensive design.

According to a third aspect, it is provided a method of detecting an object by a MIMO radar apparatus, comprising generating N waveforms for N transmission channels of the MIMO radar apparatus, N being an integer larger than 1, generating a reference signal (for example, one of the N waveforms) and phase shifting the reference signal by 90° to obtain a phase shifted reference signal, transmitting a MIMO radar waveform to the object comprising circulating the generated N waveforms forming the MIMO radar waveform through the N transmission channels with a constant relative time shift (constant frequency spacing) between the individual circulating N waveforms, receiving over N reception channels of the MIMO radar apparatus reception signals resulting from reflections of the transmitted MIMO radar waveform from the object, performing IQ mixing (demodulation) of the reception signals based on the reference signal and the phase shifted reference signal to obtain intermediate frequency signals, analog-digital converting the obtained intermediate frequency signals to obtain analog-digital converted reception signals and processing the analog-digital converted reception signals to determine at least one of a location of, distance to the MIMO radar apparatus, angle to the MIMO radar apparatus, direction relative to the MIMO radar apparatus, and velocity relative to the MIMO radar apparatus of the object.

According to an implementation of the method according to the third aspect, the analog-digital conversion of the obtained intermediate frequency signals is performed with a sampling frequency fₛ given by fₛ=N Δf, wherein Δf denotes a constant frequency spacing between the N transmission channels and a constant frequency spacing between the N transmission channels.

According to another implementation, all of the circulating N waveforms (having frequencies depending linearly on time) apart from the respective initial frequencies have the same chirp parameters. Particularly, the frequency-time slopes of all of the N waveforms may be the same. The amplitudes of all of the waveforms may also be the same.

According to another implementation, the method comprises generating digital transmission signals and digital-analog converting the digital transmission signals to obtain analog transmission signals. The generated digital transmission signals may be up-converted in frequency by means of a local oscillator.

According to another implementation, the method comprises low-pass filtering the analog transmission signals.

According to another implementation, the method comprises filtering the intermediate frequency signals for adjusting amplitudes of the intermediate frequency signals to avoid analog-to digital conversion saturation by analog filter banks that may comprise notch filters.

According to an implementation, the method comprises determining based on the analog-digital converted signals at least one of a location of or distance to the MIMO radar apparatus, angle to the MIMO radar apparatus, direction relative to the MIMO radar apparatus, and velocity relative to the MIMO radar apparatus of an object generating the reflections of the transmitted MIMO radar waveform.

The method according to the third aspect as well as the implementations of the method according to the third aspect provide the same advantages as the above-described MIMO radar apparatus according to the first aspect and implementations thereof and may be implemented in the above-described MIMO radar apparatus according to the first aspect and implementations thereof. MIMO radar apparatus according to the first aspect and implementations thereof may be configured to perform the method according to the third aspect as well as the implementations thereof.

Furthermore, it is provided a computer program product comprising computer readable instructions for, when run on a computer, performing the steps of the method according to the third aspect or any implementation thereof.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 illustrates a MIMO radar apparatus according to an embodiment.

FIG. 2 illustrates a MIMO radar apparatus according to an embodiment.

FIG. 3 illustrates a MIMO waveform suitable for the operation of a MIMO radar apparatus according to an embodiment.

FIG. 4 illustrates the effect of signal sampling with sampling frequency fₛ=N Δf on the receiver side of a MIMO radar apparatus according to an embodiment.

FIG. 5 is a flow chart illustrating a method of detecting an object by a MIMO radar apparatus according to an embodiment.

### DETAILED DESCRIPTION OF THE EMBODIMENTS

Herein, it is provided a MIMO radar apparatus and a method of detecting an object by a MIMO radar apparatus wherein the MIMO radar apparatus has a high angular resolution and, thus, allows for obtaining high-density maps. It might be provided particularly advantageous for automotive applications since it can be provided in relatively compact and inexpensive design that allows for mass production.

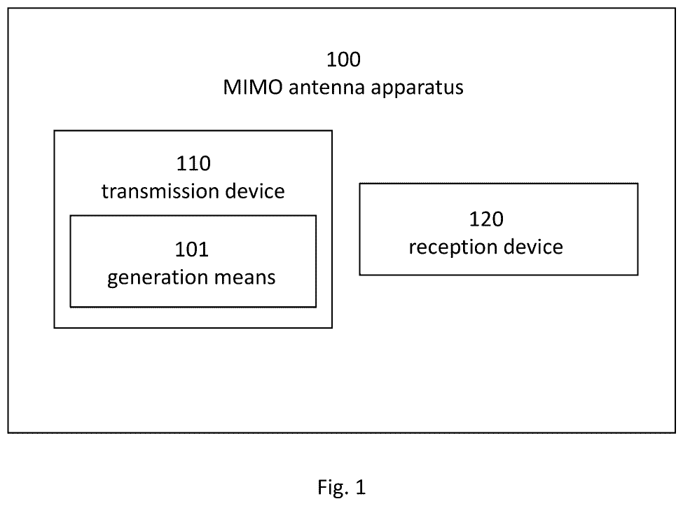

FIG. 1 illustrates an embodiment of the MIMO radar apparatus provided herein. The MIMO radar apparatus 100 shown in FIG. 1 comprises a transmission device 110 and a reception device 120. The transmission device 110 and the reception device 120 may be at least partially logically or physically separated from each other or at least integrally formed.

In the embodiment shown in FIG. 1, the transmission unit 110 is configured to transmit a MIMO radar waveform comprising circulating N waveforms forming the MIMO radar waveform through N transmission channels (antennas), N being an integer larger than 1, with a constant relative time shift (and frequency spacing) between the individual circulating N waveforms and a reception device configured to receive over N reception channels (antennas) reception signals resulting from reflections of the transmitted MIMO radar waveform. The transmission device 11 comprises generation means 101 configured to generate the MIMO radar waveform, generate a reference signal (for example, one of the N waveforms), and provide the reception device with the generated reference signal.

The reception device 120 of the MIMO radar apparatus 100 is configured to perform IQ mixing (demodulation) of the reception signals based on the reference signal to obtain intermediate frequency signals and analog-digital convert the obtained intermediate frequency signals to obtain analog-digital converted reception signals.

Particularly, the reception device 120 may be configured to analog-digital convert the obtained intermediate frequency signals with a sampling frequency fₛ given by fₛ=N Δf, wherein Δf denotes a constant frequency spacing between the N transmission channels.

The MIMO radar apparatus 100 shown in FIG. 1 operates based on both FMCW modulation and circulating individual signals (a circulating code) to provide a circulation MIMO waveform. Distances to detected objects can be determined by comparing frequencies of the reception signals with the reference signal which may be a selected as one of the waveforms transmitted over the N transmission channels. For static objects, simple frequency comparison translates directly into distances for a linear time dependence of the frequency of chirps transmitted over the N transmission channels. If the detected object is moving radially with respect to the antenna array, some Doppler shift additionally occurs (Doppler frequency is added to the reception signals) that carries information on the velocity of the moving object.

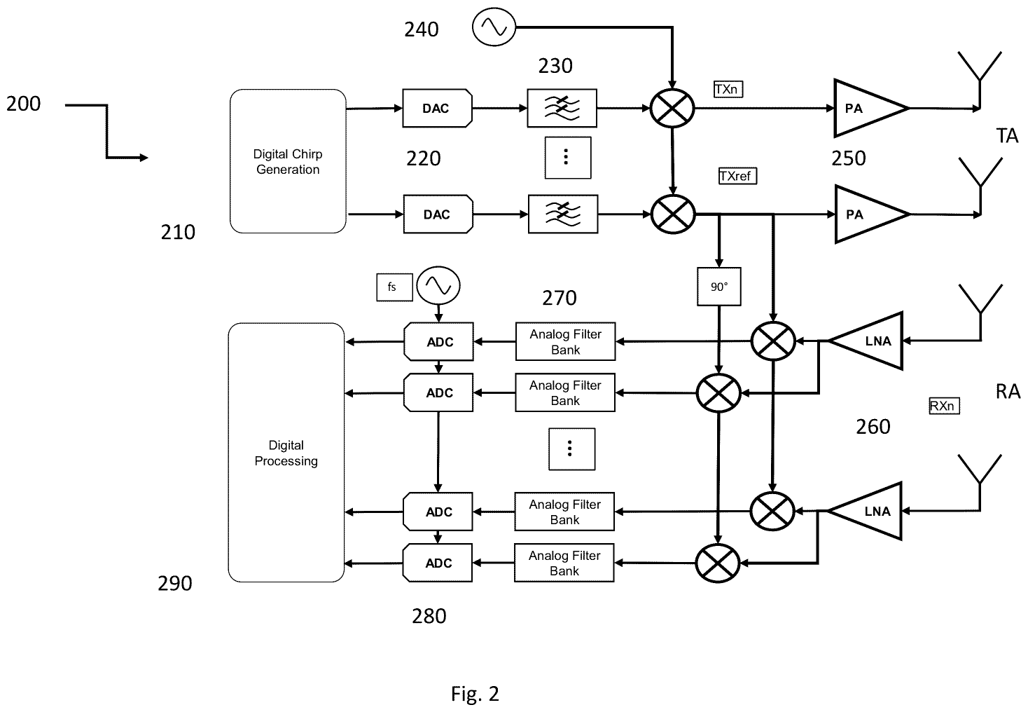

FIG. 2 shows details of an embodiment of a MIMO radar apparatus, for example, the MIMO radar apparatus 100 shown in FIG. 1. The digital FMCW MIMO radar apparatus 200 shown in FIG. 2 comprises a digital signal generator 210, for example, a Direct Digital Synthesizer (DDS), for generating digital signals (chirps) for transmission channels (antennas) Txn. Each output of the digital signal generator 210 is connected to a digital-analog converter 220 for digital-analog converting the digital signals generated by the digital signal generator 210 to obtain analog signals. The analog signals are filtered by low pass filters 230 and each of the low-pass filtered signals is up-converted by means of a local oscillator 240 to the carrier frequency, for example, 76 GHz.

One of the up-converted low-pass filtered analog signals is selected as a reference signal Txref. The reference signal as well as a 90° phase shifted version of the same are supplied to the receiver side of the digital FMCW MIMO radar apparatus 200. The up-converted low-pass filtered analog signals are amplified by amplifiers 250 and transmitted into the air by transmission antennas TA. Reflections of the transmitted signals by objects to be detected are received by reception antennas RA.

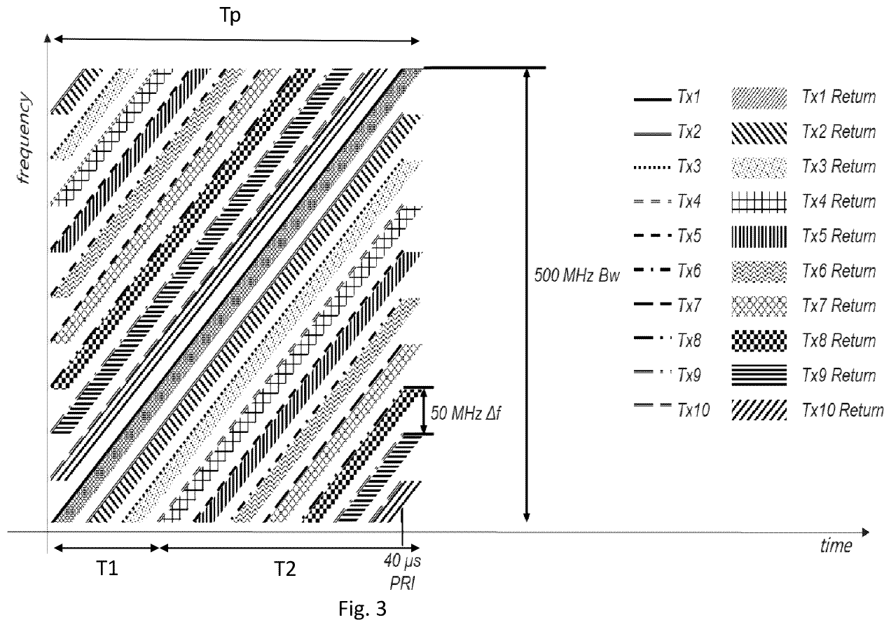

The MIMO waveform transmitted by the digital FMCW MIMO radar apparatus 200 results from circulating waveforms (the amplified up-converted low-pass filtered analog signals obtained from the digital signals generated by the digital signal generator 210) through the transmission channels Txn such that all transmission antennas TA radiate simultaneously at different frequencies. An example for the MIMO waveform is illustrated in FIG. 3. In the example shown in FIG. 3, ten transmission channels Tx1 to Tx10 are employed giving rise to a bandwidth of the MIMO waveform of 500 MHZ. FIG. 3 shows the waveforms transmitted by the individual transmission antennas TA of the digital FMCW MIMO radar apparatus 200 during a radar pulse with pulse period Tp. For each of the waveforms the inclined lines indicate signal transmission and the patterned areas adjacent to the inclined lines represent signal reception over the reception antennas RA of the digital FMCW MIMO radar apparatus 200.

Chirps with frequencies linearly depending on (increasing with) time and having the same frequency-time slope are generated by the digital signal generator 210 and waveforms are circulated through the transmission channels Txn with a constant frequency spacing Δf, for example, 50 MHz, and a constant relative time shift between the circulating N waveforms with respect to reaching the same frequencies (cf. also H. Sun, F. Brigui and M. Lesturgie, “Analysis and comparison of MIMO radar waveforms,” 2014 International Radar Conference, 13 Oct. 2014, pp. 1-6, doi: 10.1109/RADAR.2014.7060251).

In the example shown in FIG. 3, at the beginning of a radar pulse the n-th transmission channel, n=0, . . . , N−1, provides an n-th waveform starting with a frequency of n Δf. A first waveform is provided by the first transmission channel Tx1 starting with Δf with the frequency linearly increasing in time until the pulse period Tp and the bandwidth N Δf are reached. The respective frequency of each waveform temporarily increases until the bandwidth of the MIMO waveform is reached (for example, 500 MHz) and the same waveform is circulated through the same transmission channel/transmission antenna Tx2, . . . , TxN starting with frequency Δf and with a frequency temporarily increasing until n Δf is reached again at the end of the pulse time period Tp. There is a relative time shift Δt between the circulating waveforms sⁿ(t) with respect to reaching the same frequencies: sⁿ(t)˜s(t−(n−1)Δt).

As can be seen from FIG. 3 a very compact spectrum can be obtained that can be entirely used for radar signal processing for object detection. Particularly, the bandwidth needed can be reduced as compared to the one needed according to the teaching given by DE 10 2016 224 945 A1.

The reception signals resulting from reflections of the transmitted MIMO waveform and received over the reception channels Rxn of the digital FMCW MIMO radar apparatus 200 shown in FIG. 2 are amplified by (low noise) amplifiers 260. Each of the thus amplified analog reception signals is mixed with the reference signal and the 90° phased shifted reference signal, i.e., IQ demodulation is performed to obtain intermediate frequency (IQ) signals on the receiver side of the digital FMCW MIMO radar apparatus 200. The intermediate frequency signals are filtered by analog filter banks 270 comprising notch filters and the thus filtered intermediate frequency signals are analog-digital converted by analog-digital converters 280. The analog filter banks 270 are provided for avoiding signal saturation in the analog-digital converters 280 due to high-amplitude reflections caused by nearby objects.

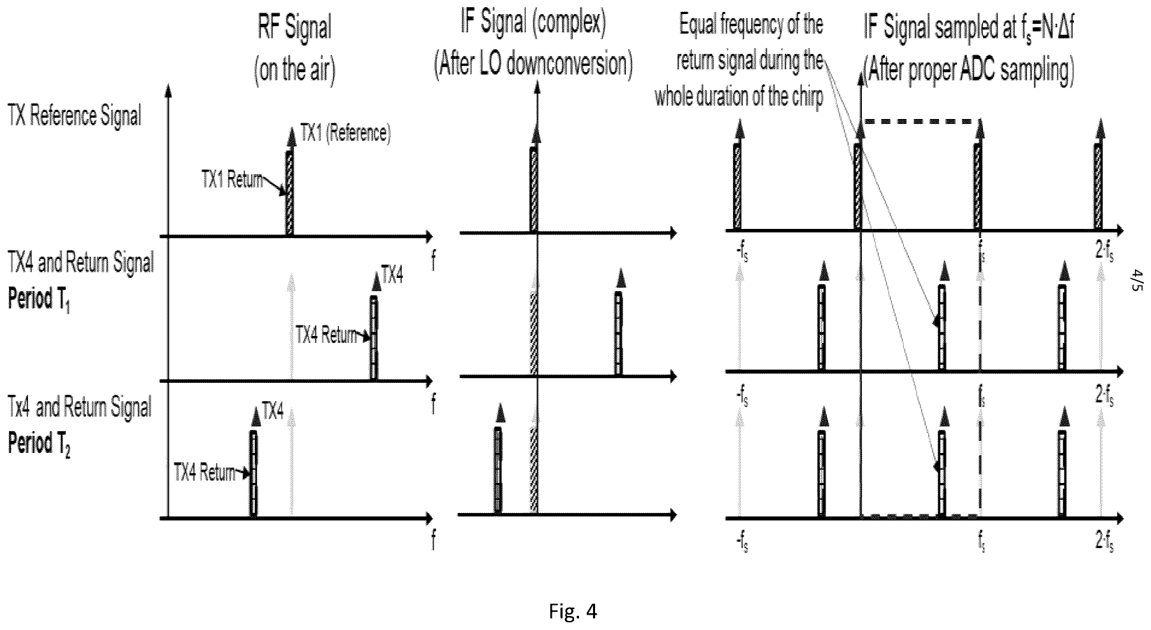

The sampling frequency fs of the analog-digital converters 280 can suitably be chosen as fₛ=N Δf, wherein Δf denotes the constant frequency spacing between the N (for example, Tx1 to Tx10) transmission channels. The effect of using this particular sampling frequency can be understood by means of FIGS. 3 and 4. Consider, for example, Tx1 transmission starting at time t=0 with frequency f=50 Hz as a reference and transmission Tx4 for comparison. In the shown example, the frequency signal spacing is Δf=50 MHz and the total number of transmission channels is N=10. In the first interval T1, the frequency difference between Tx4 and the reference Tx1 is (10−4+1) 50 MHz=350 MHz. In the second interval T2, the frequencies of the Tx4 signal are (−4+1) 50 MHz=−150 MHz below the one of the Tx1 reference.

As it is illustrated by FIG. 4 by using the sampling rate fₛ=N Δf it is achieved that in both time periods T1 and T2 the frequency differences between the frequencies of the reception signal corresponding to the n-th transmission signal Txn and the frequencies of the reception signal corresponding to the transmitted reference signal Tx are the same and, therefore, the entire spectrum can be exploited for the radar data processing. Considering again the Tx4 signal as compared to the reference signal TX1, the left column of FIG. 4 shows the above-described frequencies differences of the frequencies of the reception signals corresponding to the transmitted signals and the middle column the corresponding frequency differences of the intermediate frequency signals before analog-digital conversion (down-sampling) by the analog-digital converters 280 of the digital FMCW MIMO radar apparatus 200. The right column of FIG. 4 illustrates that due to the down-sampling with the sampling rate fₛ=N Δf it can be guaranteed that a constant positive frequency difference is maintained between the digitally down-sampled reception signal corresponding to the Tx4 signal and the digitally down-sampled reception signal corresponding to the Tx1 signal.

The digital reception signals provided by the analog-digital converters 280 are input into a digital processing unit 290 for radar data processing.

It is noted that the digital signal generator 210, digital-analog converters 220, low-pass filter 230, local oscillator 240, amplifiers 250 and transmission antennas TA shown in FIG. 2 may be comprised by the transmission device 110 of the MIMO radar apparatus 100 shown in FIG. 1 and that the reception antennas RA, amplifiers 260, analog filter banks 270, analog-digital converters 280 and digital processing unit 280 shown in FIG. 2 may be comprised by the reception device 120 of the MIMO radar apparatus 100 shown in FIG. 1. Furthermore, individual components shown in FIG. 2 may be logically and/or physically distributed or formed integrally with each other as considered suitable.

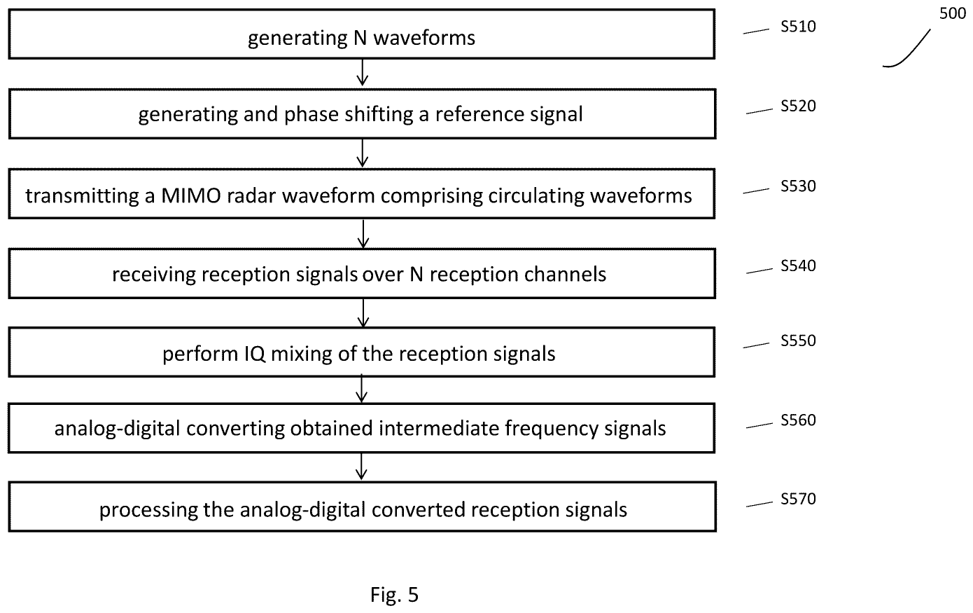

FIG. 5 illustrates an embodiment of a method 500 of detecting an object by a MIMO radar apparatus. Detecting an object may comprise determining at least one of a location of or distance to the MIMO radar apparatus, angle to the MIMO radar apparatus, direction relative to the MIMO radar apparatus, and velocity relative to the MIMO radar apparatus of the object generating reflections of a transmitted MIMO radar waveform.

In step S510 of the method 500 illustrated in FIG. 5 N waveforms for N transmission channels of the MIMO radar apparatus, N being an integer larger than 1, are generated. Further, the method 500 comprises in step S520 generating a reference signal (for example, one of the N waveforms) and phase shifting the reference signal by 90° to obtain a phase shifted reference signal. Furthermore, the method 500 comprises transmitting S530 a MIMO radar waveform to the object that is to be detected comprising circulating the generated N waveforms forming the MIMO radar waveform through the N transmission channels with a constant relative time shift (and frequency spacing) between the individual circulating N waveforms.

Reception signals resulting from reflections of the transmitted MIMO radar waveform from the object are received S540 over N reception channels of the MIMO radar apparatus reception signals. These reception signals are subject to IQ mixing (demodulation) S550 based on the reference signal and the phase shifted reference signal in order to obtain intermediate frequency signals. These intermediate frequency signals are analog-digital converted S560 (possibly after having been filtered by analog filter banks comprising notch filters) to obtain analog-digital converted reception signals. The analog-digital converted reception signals may be obtained by down-sampling of the (filtered) intermediate frequency signals with a sampling frequency fₛ given by fₛ=N Δf, wherein Δf denotes a constant frequency spacing between the N transmission channels and a constant frequency spacing between the N transmission channels. The analog-digital converted reception signals are processed S570 to determine at least one of a location of, distance to the MIMO radar apparatus, angle to the MIMO radar apparatus, direction relative to the MIMO radar apparatus, and velocity relative to the MIMO radar apparatus of the object, for example.

For example, the MIMO radar apparatus 100 shown in FIG. 1 or the MIMO radar apparatus 200 shown in FIG. 2 can be used for performing the method 500 illustrated in FIG. 5 and this method may be implemented in the MIMO radar apparatus 100 shown in FIG. 1 or the MIMO radar apparatus 200 shown in FIG. 2.

All previously discussed embodiments are not intended as limitations but serve as examples illustrating features and advantages of the invention. It is to be understood that some or all of the above described features can also be combined in different ways.

What is claimed is:

1. A multiple-input-multiple-output (MIMO) radar apparatus, comprising:
a reception device; and
a transmission device configured to:
generate a MIMO radar waveform comprising circulating N waveforms forming the MIMO radar waveform through N transmission channels with a constant relative time shift between the circulating N waveforms, where N is an integer larger than 1;
generate a reference signal;
transmit the MIMO radar waveform; and
provide the reception device with the generated reference signal;
wherein the reception device is configured to:
receive, over N reception channels, reception signals resulting from reflections of the transmitted MIMO radar waveform;
perform IQ mixing on the reception signals based on the reference signal to obtain intermediate frequency signals; and
perform analog-digital conversion on the obtained intermediate frequency signals to obtain analog-digital converted reception signals.

2. The radar apparatus according to claim 1, wherein performing the analog-digital conversion utilizes a sampling frequency fₛ given by fₛ=N Δf, wherein Δf denotes a constant frequency spacing between the N transmission channels.

3. The radar apparatus according to claim 1, wherein the reference signal is one of the N waveforms of the MIMO radar waveform.

4. The radar apparatus according to claim 1, wherein all of the N waveforms other than respective initial frequencies have the same chirp parameters.

5. The radar apparatus according to claim 1, wherein the transmission device or the reception device is configured to phase shift the reference signal by 90° to obtain a phase shifted reference signal; and
wherein the reception device is configured to perform the IQ mixing based on the phase shifted reference signal.

6. The radar apparatus according to claim 1, wherein the transmission device comprises a digital signal generator configured to generate digital transmission signals and a digital-analog converter configured to perform digital-analog conversion on the digital transmission signals to obtain analog transmission signals.

7. The radar apparatus according to claim 6, wherein the transmission device comprises a local oscillator configured to up-convert in frequency the generated digital transmission signals.

8. The radar apparatus according to claim 6, wherein the transmission device comprises low-pass filters configured to low-pass filter the analog transmission signals.

9. The radar apparatus according to claim 1, wherein the reception device comprises analog filter banks configured to filter the intermediate frequency signals for adjusting amplitudes of the intermediate frequency signals to avoid analog-to-digital conversion saturation.

10. The radar apparatus according to claim 9, wherein the analog filter banks comprise notch filters.

11. The radar apparatus according to claim 1, wherein the reception device comprises a digital processing unit configured to:
receive the digital-analog converted reception signals; and
determine, with respect to an object generating the reflections of the transmitted MIMO radar waveform, at least one of:
a location of the object relative to the MIMO radar apparatus,
distance of the object relative to the MIMO radar apparatus,
angle of the object relative to the MIMO radar apparatus,
direction of the object relative to the MIMO radar apparatus, or
velocity of the object relative to the MIMO radar apparatus.

12. The radar apparatus according to claim 1, wherein the radar apparatus is part of a vehicle, an automobile, an automated guided vehicle, a robot, a home monitoring system, or a health monitoring system.

13. A method for detecting an object, comprising
generating, by a multiple-input-multiple-output (MIMO) radar apparatus, N waveforms for N transmission channels of the MIMO radar apparatus, where N is an integer larger than 1;
generating, by the MIMO radar apparatus, a reference signal and phase shifting the reference signal by 90° to obtain a phase shifted reference signal;
transmitting, by the MIMO radar apparatus, a MIMO radar waveform to the object, wherein the MIMO radar waveform comprises circulating the generated N waveforms forming the MIMO radar waveform through the N transmission channels with a constant relative time shift between the circulating N waveforms;
receiving, by the MIMO radar apparatus, over N reception channels of the MIMO radar apparatus, reception signals resulting from reflections of the transmitted MIMO radar waveform from the object;
performing, by the MIMO radar apparatus, IQ mixing on the reception signals based on the reference signal and the phase shifted reference signal to obtain intermediate frequency signals;
performing, by the MIMO radar apparatus, analog-digital conversion on the obtained intermediate frequency signals to obtain analog-digital converted reception signals; and
processing, by the MIMO radar apparatus, the analog-digital converted reception signals to determine at least one of:
a location of the object,
distance of the object relative to the MIMO radar apparatus,
angle of the object relative to the MIMO radar apparatus,
direction of the object relative to the MIMO radar apparatus, or
velocity of the object relative to the MIMO radar apparatus.

14. The method according to claim 13, wherein the analog-digital conversion of the obtained intermediate frequency signals is performed with a sampling frequency fₛ given by fₛ=N Δf, wherein Δf denotes a constant frequency spacing between the N transmission channels and a constant frequency spacing between the N reception channels.

15. The method according to claim 13, wherein the reference signal is one of the N waveforms of the MIMO radar waveform.

16. The method according to claim 13, wherein all of the N waveforms other than respective initial frequencies have the same chirp parameters.

17. The method according to claim 13, wherein the transmission device comprises a digital signal generator configured to generate digital transmission signals and a digital-analog converter configured to perform digital-analog conversion on the digital transmission signals to obtain analog transmission signals.

18. The method according to claim 17, wherein the transmission device comprises a local oscillator configured to up-convert in frequency the generated digital transmission signals.

19. A non-transitory computer-readable medium having processor-executable instructions stored thereon for detecting an object, wherein the processor-executable instructions, when executed, facilitate performance of the following
generating, by a multiple-input-multiple-output (MIMO) radar apparatus, N waveforms for N transmission channels of the MIMO radar apparatus, where N is an integer larger than 1;
generating, by the MIMO radar apparatus, a reference signal and phase shifting the reference signal by 90° to obtain a phase shifted reference signal;
transmitting, by the MIMO radar apparatus, a MIMO radar waveform to the object, wherein the MIMO radar waveform comprises circulating the generated N waveforms forming the MIMO radar waveform through the N transmission channels with a constant relative time shift between the circulating N waveforms;
receiving, by the MIMO radar apparatus, over N reception channels of the MIMO radar apparatus, reception signals resulting from reflections of the transmitted MIMO radar waveform from the object;
performing, by the MIMO radar apparatus, IQ mixing on the reception signals based on the reference signal and the phase shifted reference signal to obtain intermediate frequency signals;
performing, by the MIMO radar apparatus, analog-digital conversion on the obtained intermediate frequency signals to obtain analog-digital converted reception signals; and
processing, by the MIMO radar apparatus, the analog-digital converted reception signals to determine at least one of:
a location of the object,
distance of the object relative to the MIMO radar apparatus,
angle of the object relative to the MIMO radar apparatus,
direction of the object relative to the MIMO radar apparatus, or
velocity of the object relative to the MIMO radar apparatus.

20. The non-transitory computer-readable medium according to claim 19, wherein the analog-digital conversion of the obtained intermediate frequency signals is performed with a sampling frequency fₛ given by fₛ=N Δf, wherein Δf denotes a constant frequency spacing between the N transmission channels and a constant frequency spacing between the N reception channels.
